(19) United States
(12) Patent Application Publication
(10) Pub. No.: US 2025/0358235 A1
(43) Pub. Date: Nov. 20, 2025

(54) Load Balancing Between Network Devices Using Queue Sharing

(71) Applicant: MELLANOX TECHNOLOGIES, LTD., Yokneam (IL)

(72) Inventors: Noam Bloch, Bat Shlomo (IL); Lior Narkis, Petah Tikva (IL); Daniel Marcovitch, Yokneam Illit (IL); Miriam Menes, Tel Aviv (IL); Gil Bloch, Zichron Ya'akov (IL); Ran Avraham Koren, Haifa (IL)

(21) Appl. No.: 18/664,336

(22) Filed: May 15, 2024

(51) Int. Cl. H04L 47/62; G06F 9/50

(52) U.S. Cl. CPC H04L 47/62; G06F 9/5083

(57) ABSTRACT

A system includes one or more processors, and multiple network devices to connect the one or more processors to a network. The one or more processors are to issue work requests to the multiple network devices, by posting work descriptors on one or more shared queues that are each accessible to the multiple network devices. The network devices are to pull the work descriptors from the one or more shared queues, and to execute the work requests responsively to the work descriptors.

### TECHNICAL FIELD

The present description relates generally to network communication, and particularly to methods and systems for load balancing between network devices.

### BACKGROUND

In some communication systems, a processor or a group of processors may connect to a network using multiple network devices. One example of such a system is a Graphics Processing Unit (GPU) that connects to a network using two Network Interface Controllers (NICs) or Data Processing Units (DPUs).

### SUMMARY

An embodiment that is described herein provides a system including (i) one or more processors and (ii) multiple network devices to connect the one or more processors to a network. The one or more processors are to issue work requests to the multiple network devices, by posting work descriptors on one or more shared queues that are each accessible to the multiple network devices. The network devices are to pull the work descriptors from the one or more shared queues, and to execute the work requests responsively to the work descriptors.

Typically, in posting a work descriptor on the shared queue, a processor is to make the work descriptor available to any of the multiple network devices.: In some embodiments, upon issuing a work descriptor on a shared queue, a processor is to issue a doorbell to the multiple network devices, notifying the multiple network devices that the work descriptor has been posted. Typically, a network device is to pull a work descriptor from the shared queue, not in response to an assignment of the work descriptor to the network device by the one or more processors.

In an embodiment, a network device is to estimate a communication load experienced by the network device, and to pull a work descriptor in response to finding that the estimated communication load is sufficiently low, in accordance with a defined criterion.

In a disclosed embodiment, the one or more shared queue are multiple shared queues that are each accessible to the multiple network devices; the one or more processors are to issue the work requests to the multiple network devices by posting the work descriptors on the multiple shared queues; and a network device is to choose a queue from among at least the multiple shared queues in accordance with a Quality-of-Service (QoS) criterion, and to pull a work descriptor from the chosen queue.

In some embodiments, a shared queue is associated with a shared read pointer that is indicative of a head of the shared queue, and, upon attempting to pull a work descriptor from the shared queue, a network device is to increment the read pointer using an atomic fetch-and-add command. In an embodiment, the atomic fetch-and-add command specifies a limit that prevents the incremented read pointer from overrunning a write pointer of the shared queue. In an example embodiment, the one or more processors and the multiple network devices communicate over one or more peripheral buses using a bus communication protocol; and the atomic fetch-and-add command is implemented as an extension of the bus communication protocol.

In some embodiments, the read pointer is stored in a memory of one of the network devices, and the network device is to perform the atomic fetch-and-add command in the memory of the one of the network devices. In an example embodiment, the network device is to perform the atomic fetch-and-add command over a dedicated peer-to-peer connection between the network devices.

In an alternative embodiment, the read pointer is stored in a memory of one of the processors, and the network device is to perform the atomic fetch-and-add command in the memory of the one of the processors. In an embodiment, the network device is to roll-back the incremented read pointer in response to finding that, following the atomic fetch-and-add command, the read pointer overruns a write pointer of the shared queue. In other embodiments, in response to finding that the read pointer overruns a write pointer of the shared queue following the atomic fetch-and-add command, the network device is to wait for a processor to post a new work descriptor, and then pull the new work descriptor.

There is additionally provided, in accordance with an embodiment that is described herein, a method including issuing work requests from one or more processors to multiple network devices that connect the one or more processors to a network, by posting work descriptors on one or more shared queues that are each accessible to the multiple network devices. In the multiple network devices, the work descriptors are pulled from the one or more shared queues, and the work requests are executed responsively to the work descriptors.

The present description will be more fully understood from the following detailed description of the embodiments thereof, taken together with the drawings in which:

### BRIEF DESCRIPTION OF THE DRAWINGS

FIG. 1 is a block diagram that schematically illustrates a computing system employing load balancing between two network devices using queue sharing, in accordance with an embodiment that is described herein;

FIG. 2 is a block diagram that schematically illustrates a computing system employing load balancing among four network devices using queue sharing, in accordance with an alternative embodiment that is described herein;

FIG. 3 is a flow chart that schematically illustrates a method for load balancing among two network devices using queue sharing, in accordance with an embodiment that is described herein;

FIG. 4 is a diagram that schematically illustrates a Consumer Index (CI) overrun scenario occurring during queue sharing, in accordance with an embodiment that is described herein; and

FIG. 5 is a flow chart that schematically illustrates a method for joint load balancing and Quality-of-Service (QoS), in accordance with an embodiment that is described herein.

### DETAILED DESCRIPTION OF EMBODIMENTS

### Overview

Various existing and emerging computing system configurations comprise a plurality of network devices, e.g., network adapters or Data Processing Units (DPUs), that together serve a processor or a group of processors. As communication rates increase, it becomes important to utilize the network devices' resources efficiently. In particular, it is important to balance the communication load among the network devices. A well-balanced set of network devices provides superior performance, e.g., high throughput, low latency, low jitter and fast completion of jobs involving multiple network operations.

Embodiments that are described herein provide methods and systems that balance the communication load among multiple network devices. The disclosed techniques balance the load by using (i) shared queues that are each accessible to the various network devices, and (ii) a “work stealing” scheme in which the network devices pull work requests from the shared queues rather than being pushed work requests. The description that follows refers mainly to network adapters, by way of example, but the disclosed techniques are applicable to network devices of any other suitable type.

The disclosed techniques are also applicable to various types of accelerators connected to a processor (e.g., compression accelerators, cryptography accelerators, and others). Generally put, the disclosed techniques, using “work stealing” from shared queues, can be used for load balancing among various kinds of peripheral devices that serve one or more processors. Peripheral devices may comprise, for example, network devices and accelerators.

In a typical embodiment, a system comprises one or more processors that connect to a network via multiple network adapters. A processor issues work requests to the network adapters by posting work descriptors on one or more shared queues that are each accessible to the multiple network adapters. The network devices pull the work descriptors from the shared queues and execute the corresponding work requests.

In the present context, the term “work descriptor” refers to a data item that is posted on a work queue in response to a work request. In a typical, although not limiting, example, a work request is generated by an application, and a corresponding work descriptor is posted on a work queue by a software driver associated with the network device. A work descriptor may comprise, or point to, any suitable information relating to the work request to be performed. Such information may comprise, for example, the type of operation to be performed, related addresses, data, metadata, and/or any other suitable information. Pulling a work descriptor from a queue, by a network device, typically involves reading the work descriptor.

In an example embodiment, each network adapter continually estimates its current or expected communication load. When the estimated load is sufficiently low, e.g., below a defined threshold, the network adapter pulls one or more work descriptors from one of the shared queues and executes the corresponding work requests. Example techniques for load estimation that can be used for this purpose are described in U.S. patent application Ser. No. 18/638,756, entitled “Load balancing between network devices based on communication load,” which is assigned to the assignee of the present patent application and whose disclosure is incorporated herein by reference.

In this manner, each network adapter is responsible to ensure its resources are utilized efficiently. The work requests and work descriptors are not pre-assigned by the processor to any specific network adapter. The processor may not be aware of the identity of the network adapter that executes a particular work request, or even that the work is being distributed among multiple network adapters.

In some embodiments, a given shared queue has a write pointer (also referred to as a Producer Index—PI) and a read pointer (also referred to as a Consumer Index—CI) stored in memory. The write pointer points to the next location in the queue to be written-to by the processor. The read pointer is accessible to the multiple network adapters, and points to the next location in the queue to be read-from by the network adapters. Upon reading a work descriptor from a shared queue, the network adapter typically increments the read counter of the queue using an atomic fetch-and-add command. Several techniques for preventing the read pointer from overrunning the write pointer, e.g., due to a race condition between network adapters, are described herein.

In a typical implementation, the system comprises multiple shared queues that may each have pending work descriptors. In some embodiments, the network adapters choose which of the queues to serve in accordance with a defined Quality-of-Service (QoS) criterion. In other words, the network adapters serve the shared queues while ensuring both QoS and load balancing. In an example embodiment, a network adapter first uses a QoS criterion to select a shared queue from among the shared queues having pending work descriptors, and then verifies that its communication load is sufficiently low to serve the selected queue. When using this order of operations (QoS decision first, load balancing decision second), the network adapters have visibility to all pending work, and work is not committed to a network adapter until after the network adapter has made its QoS decision (i.e., has chosen which queue to serve). As a result, the network adapters can make better QoS decisions.

### System Description

FIG. 1 is a block diagram that schematically illustrates a computing system 20 employing load balancing between two network devices using queue sharing, in accordance with an embodiment that is described herein. The network devices may comprise network adapters, such as Ethernet Network Interface Controllers (NICs) or InfiniBand™ (IB) Host Channel Adapters (HCAs). Alternatively, the disclosed techniques can be used with other suitable types of network devices, e.g., Data Processing Units (DPUs—also referred to as “Smart NICs”), or with suitable peripheral devices such as accelerators (compression accelerators, cryptography accelerators, etc.).

In the embodiment of FIG. 1, system 20 comprises a processor 24 and two NICs 28. Processor 24 uses NICs 28 to transmit and receive communication traffic over a network 32. Processor 24 may comprise, for example, a Central Processing Unit (CPU), a Graphics Processing Unit (GPU), or any other suitable type of processor. The description below refers mainly to a single processor, for simplicity of explanation. In alternative embodiments, the disclosed techniques can be used with a group of processors that together communicate via network adapters 28. In the present example system 20 comprises two NICs, although any other suitable number of NICs can be used.

Each NIC 28 communicates with processor 24 via a peripheral bus 36. In the present example, bus 36 is a Peripheral Component Interconnect express (PCIe) bus. Alternatively, any other suitable peripheral bus, e.g., NVLINK or Compute Express Link (CXL), can be used. Each NIC communicates with network 32 using one or more network ports 40. Further alternatively, any of NICs 28 may be connected to processor 24 by a direct connection, i.e., not via a peripheral bus.

A given NIC typically comprises a host interface for communicating with processor 24 over bus 36, one or more network interfaces for communicating with network 32, and circuitry that carries out the various processing tasks of the network adapter.

System 20 further comprises a memory 44, typically a Random-Access Memory (RAM). Memory 44 is accessible to processor 24 and by NICs 28. Processor 24 maintains in memory 44 one or more shared Work Queues (WQs) 48 and one or more shared Completion Queues (CQs) 52. An alternative embodiment, which uses different completion notification semantics instead of shared CQs, is described below. In the present example, WQs 48 and CQs 52 are accessible to both NIC1 and NIC2. When a given NIC supports multiple ports, Physical Functions (PFs) and/or Virtual Functions (VFs), the shared WQ is typically shared among the various ports, PFs and/or VFs.

The figure illustrates a single shared WQ 48 and a single CQ 52, for the sake of clarity. In many practical implementations, multiple shared WQs 48 and multiple CQs 52 can be used. Certain aspects of handling multiple shard WQs, in the context of Quality-of-Service (QoS), are addressed further below. In the present example, shared WQ 48 is stored in memory 44 of processor 24. Alternatively, shared WQ 48 may be stored in any other suitable location, e.g., in a memory of one of NICs 28.

When a shared WQ 48 is stored in the memory of one of the NICs, other NICs 28 typically access the shared WQ using peer-to-peer communication. In one embodiment, the peer-to-peer communication is conducted over buses 36. In another embodiment, the peer-to-peer communication is conducted over a dedicated peer-to-peer connection (separate from buses 36) between NICs 28.

When the system comprises multiple processors 24, each processor 24 typically has its own set of (one or more) shared WQs 48 and CQs 52. In other words, the term “shared” refers to the queues being accessible to multiple network adapters, not to multiple processors. More generally, however, the disclosed techniques can also be used in schemes in which different processors 24 can post work descriptors on a given queue. In some embodiments, the system may also comprise one or more WQs that are not shared, i.e., WQs that are associated with a specific NIC.

In a typical embodiment, processor 24 issues Work Requests (WRs) to NICs 28 by posting Work-Queue Elements (WQEs) 56 on shared WQ 48. A WQE may request the NICs, for example, to perform a Remote Direct Memory Access (RDMA) WRITE transaction that writes certain data to a remote memory across network 32. As another example, the WQE may request the NICs to perform an RDMA READ transaction that fetches certain data from a remote memory across network 32. Other suitable types of WQEs (like SEND) can also be used.

NICs 28 pull WQEs from the shared WQ and execute the corresponding WRs. Upon completion of a WR by a certain NIC, the NIC returns a completion notification to the processor, e.g., by posting a Completion-Queue Element (CQE) on CQ 52. In another embodiment, the completion notification is implemented in the form of increasing a counter by a value. The counter address or index, and the value, can be defined in the WR. This mechanism, sometimes referred to as “counting events”, is described, for example in “The Portals 4.0 Network Programming Interface,” Sandia National Laboratories, November 2012. See in particular section 3.14.

In some embodiments, CQs 52 are shared among NICs 28, as well. In one such embodiment, before posting a CQE on a shared CQ, a NIC first reserves (“steals”) a location in the shared CQ for the CQE to be posted. The NIC may reserve a location, for example, by performing an atomic fetch-and-add on the Producer Index (PI) of the CQ. The CQE can then be posted in the reserved location. In alternative embodiments, instead of using shared CQs, system 20 may use completion notification semantics such as the “counting events” mechanism cited above. In such an embodiment, once a NIC completed processing of a given WQE, the NIC increments a counting-event by a value. Both the counting-event and the increment value are specified in the WQE.

The embodiments described herein refer mainly to WQs, CQs, WQEs and CQEs, by way of non-limiting example. The disclosed techniques can be used with any other suitable types of queues, work descriptors and completion notifications. Thus, in the present context, the terms “WQ” and “WQE” are regarded herein as examples of queues and work descriptors, respectively. Although some of the terminology in the following description is commonly used in InfiniBand™ (IB) networks, the disclosed techniques are in no way limited to any specific communication protocol or network type.

As seen in FIG. 1, shared WQ 48 stores one or more valid WQEs 56. WQ 48 has a read pointer, denoted Consumer Index (CI) in the figure, which points to the head of the WQ (the next location to be read from by NICs 28). WQ 48 also has a write pointer, denoted Producer Index (PI) in the figure, which points to the tail of the WQ (the next location to be written to by processor 24). In some embodiments, both CI and PI are stored in memory 44. In other embodiments, at least CI is stored in a memory of one of NICs 28—This embodiment is addressed in detail further below.

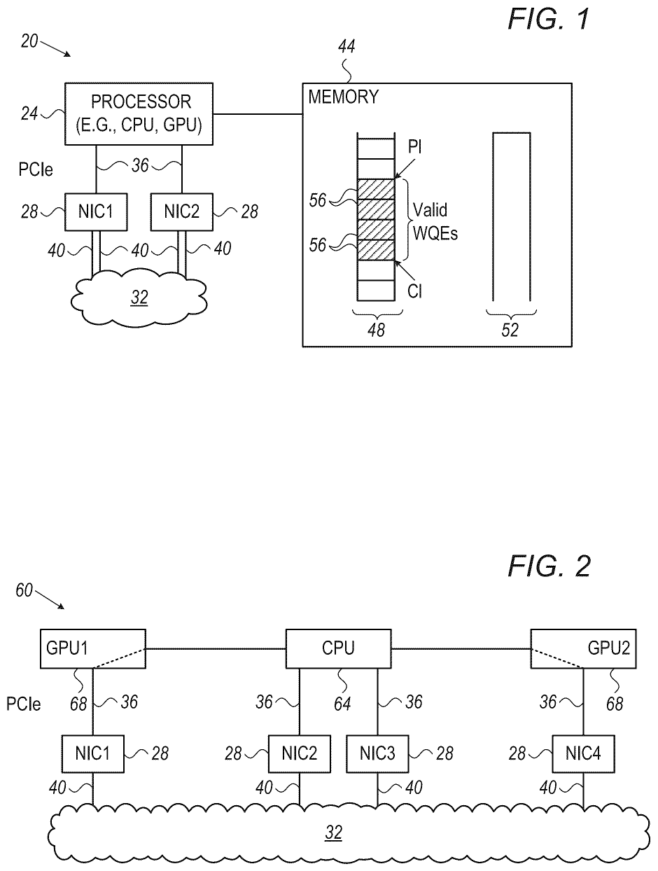

FIG. 2 is a block diagram that schematically illustrates a computing system 60 employing load balancing among four network adapters using queue sharing, in accordance with an alternative embodiment that is described herein. System 60 comprises a CPU 64, two GPUs 68 denoted GPU1 and GPU2, and four NICs 28 denoted NIC1-NIC4.

In the present example, CPU 64 is connected by suitable communication interfaces to GPU1 and GPU2. NIC1 is connected to GPU1 by a PCIe link 36, NIC2 and NIC3 are connected to CPU 64 by two respective PCIe links 36, and NIC4 is connected to GPU2 by a fourth PCIe link 36. Given this physical connectivity, CPU 64 is able to exchange communication traffic with network 32 via any of the four NICs 28 (NIC1-NIC4). The memory and shared queues are not seen in this figure, for clarity.

As demonstrated by FIGS. 1 and 2, the phrase “a processor exchanges communication traffic via a network adapter,” in various grammatical forms, refers both to direct and indirect physical connection between the processor and the network adapter. In the example of FIG. 2, CPU 64 may use the disclosed techniques for balancing the load of the communication traffic exchanged via NIC1-NIC4.

The configurations of systems 20 and 60, as shown in FIGS. 1 and 2, are example configurations that are chosen purely for the sake of conceptual clarity. In alternative embodiments, any other suitable configurations can be used. Elements that are not necessary for understanding the principles of the disclosed solution have been omitted from the figures for clarity.

The various elements of systems 20 and 60, including the various disclosed processors and network adapters, may be implemented in hardware, e.g., in one or more Application-Specific Integrated Circuits (ASICs) or FPGAS, in software, or using a combination of hardware and software elements. In some embodiments, certain elements of the disclosed processors and network adapters may be implemented, in part or in full, using one or more general-purpose processors, which are programmed in software to carry out the functions described herein. The software may be downloaded to any of the processors in electronic form, over a network, for example, or it may, alternatively or additionally, be provided and/or stored on non-transitory tangible media, such as magnetic, optical, or electronic memory.

### Load Balancing Between Network Devices Using Queue Sharing

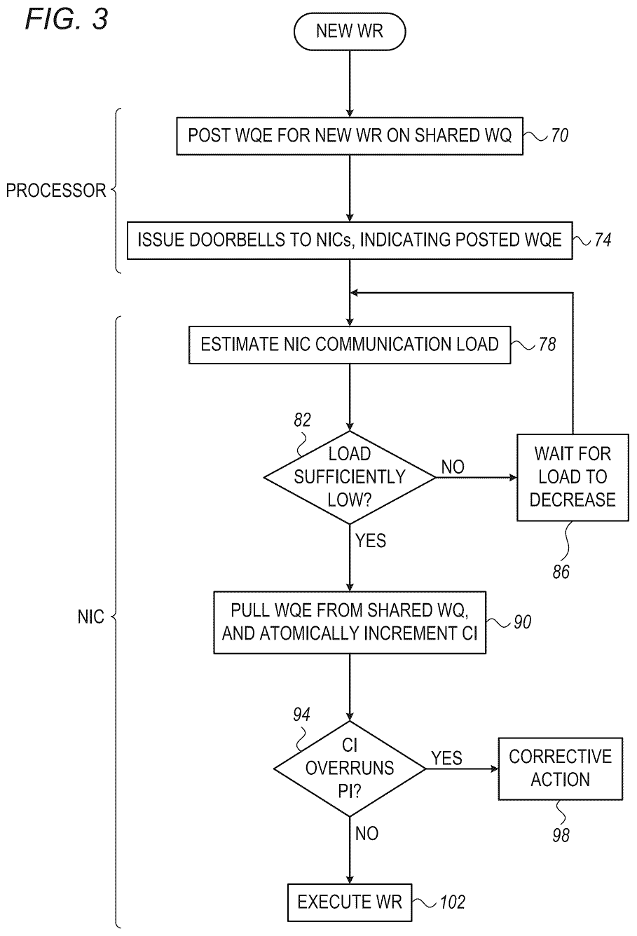

FIG. 3 is a flow chart that schematically illustrates a method for load balancing among two network adapters using queue sharing, in accordance with an embodiment that is described herein. In the present example the method is carried out by processor 24 and NICs 28 of system 20 (FIG. 1).

The method begins when processor 24 has a new Work Request (WR) to be executed by NICs 28. At a WQE posting stage 70, processor 24 posts a WQE, which describes the new WR, on shared WQ 48. At a doorbell issuing stage 74, processor 24 issues a doorbell to each of NIC1 and NIC2, notifying the NICs that a new WQE has been posted on shared WQ 48. The doorbell may specify any relevant information, for example the current value of PI of the shared WQ.

The following stages (78-102) are carried out by each of NIC1 and NIC2 in response to the doorbell, independently of the other NIC. At a load estimation stage 78, the NIC estimates its current or expected communication load. Any suitable method can be used for this purpose, such as the methods described in U.S. patent application Ser. No. 18/638,756, cited above. Example types of communication loads that can be estimated and used for load balancing include:
“Outbound load”—The total amount of data that was provided to the NIC for sending to the network but not yet completed. In an example embodiment, the outbound load can be estimated as the total byte count accumulated over all WRITE WQEs that were pulled by the NIC but not yet completed. Within the total byte count of uncompleted WRITE WQEs, a more accurate estimate would exclude the number of bytes that were already sent to the network.
“Inbound load”—The total amount of data that was requested to be read by NIC over the network but not yet completed. An example estimate of the inbound load comprises the total byte count accumulated over all READ WQEs that were pulled by the NIC but not yet completed. Here, too, within the total byte count of uncompleted READ WQEs, a more accurate estimate would exclude the number of bytes that were already fetched over the network.

At a load checking stage 82, the NIC checks whether the estimated load is sufficiently low to warrant obtaining additional work from shared WQ 48. For example, the NIC may compare the estimated load to a defined threshold (which can be fixed or adaptive).

If the estimated load is not sufficiently low, the NIC waits for the load to decrease, at a waiting stage 86, and then loops back to stage 78. If, on the other hand, the estimated load is sufficiently low, the NIC pulls a new WQE from the head of shared WQ 48, at a pulling stage 90. To pull a new WQE, the NIC reads the value of CI and then reads the WQE from the location pointed-to by CI.

Upon pulling the WQE, the NIC increments CI to point to the next WQE. In some embodiments, the NIC increments CI atomically using an atomic fetch-and-add command. The term “atomic” in this context means that no other entity is permitted to modify CI before the fetch-and-add command is completed. The command typically specifies an “add value” by which CI is to be incremented.

In an embodiment, the NIC may pull multiple WQEs from the shared WQ using a single atomic fetch-and-add command. In this embodiment, the “add value” in the command is indicative of the number of WQEs being pulled. As a result of the fetch-and-add command, the NIC receives a CI. From this CI, the NIC fetches a WQE.

At a CI overrun checking stage 94, the NIC checks whether the incremented CI (read pointer) overruns the PI (write pointer) of the shared WQ. Such an overrun may occur when the NIC and another NIC compete in pulling the same WQE from the shared WQ, and the NIC has lost the competition but nevertheless incremented the CI. If an overrun is detected, the NIC initiates a corrective action at a corrective action stage 98. Examples of overrun conditions and possible corrective actions are discussed further below.

If no CI overrun is detected at stage 94, the NIC executes the new WR, in accordance with the newly-pulled WQE, at a WR execution stage 102.

### Prevention/Correction of CI Overrun

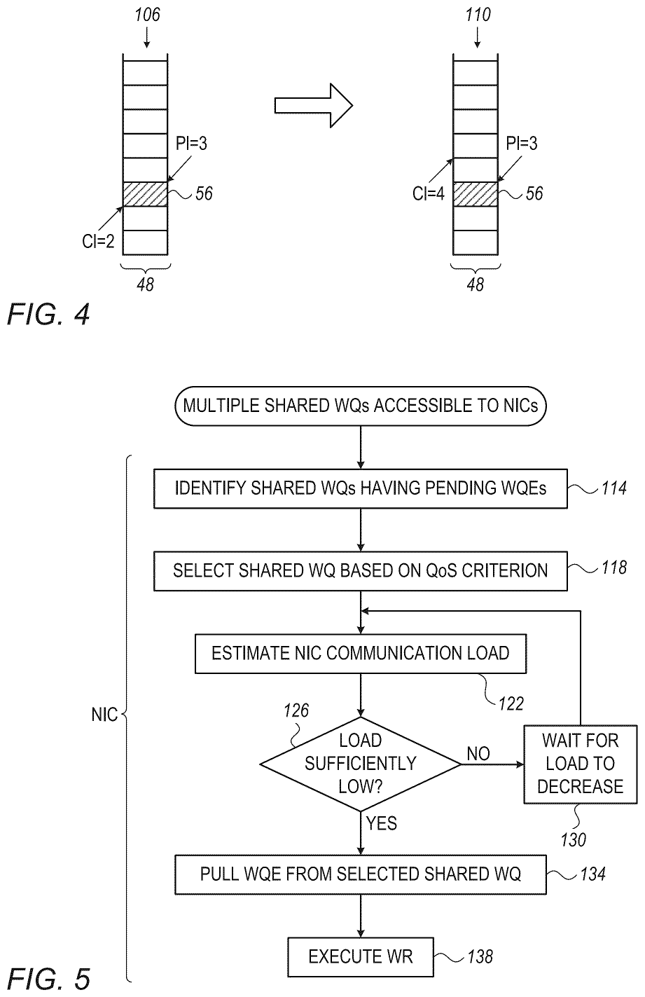

FIG. 4 is a diagram that schematically illustrates a Consumer Index (CI) overrun scenario occurring during queue sharing, in accordance with an embodiment that is described herein.

The left-hand side of the figure (denoted 106) shows the state of a shared WQ 48 that stores a single WQE 56. In this state, CI=2 and PI=3.

The right-hand side of the figure (denoted 110) shows the state of the shared WQ after the NIC attempts to pull WQE 56, fails due to another NIC pulling the same WQE, but nevertheless (erroneously) increments the CI. In such a case, the CI has been incremented twice (once correctly by the other NIC that pulled the WQE successfully, and once erroneously by the NIC that lost the competition for the WQE). As a result, PI=3, and CI=4, which overruns the PI.

As can be appreciated, a scenario in which CI overruns PI is an undesired scenario. In the present context, the term “overrun condition” refers to any relation between CI and PI that needs to be prevented or corrected. In some embodiments CI is not permitted to exceed PI, i.e., CI>PI is defined as an overrun condition. A stricter overrun condition is CI≥PI, i.e., CI is also not permitted to be equal to PI. In other embodiments, a less stringent overrun condition may be CI>PI+N, wherein N is a predefined integer such as 1, 2 or 3 (i.e., CI is permitted to exceed PI by some predefined integer N). Further alternatively, other suitable overrun conditions can be defined.

In various embodiments, NICs 28 may take various preventive or corrective measures to prevent or correct CI overrun.

In some embodiments, upon pulling a WQE from shared WQ 48, NICs 28 increment the CI using a new atomic fetch-and-add command, which is referred to herein as “atomic fetch-and-add with limit”. This command specifies (i) an “add value” by which CI is to be incremented, and (ii) a limit that prevents the incremented CI from overrunning PI. For example, if the current value of PI is 3 (as in the example of FIG. 4), and the applicable overrun condition is CI≥PI, then the NIC may increment CI using an “atomic fetch-and-add with limit” in which the limit is set to 3. If the intended value of CI exceeds the limit specified in the command, CI is not incremented and the command returns an indication that CI was not incremented.

In an example embodiment, the “atomic fetch-and-add with limit” command is formatted as an extension of the peripheral-bus protocol used for communicating over bus 36 (e.g., PCIe or NVLINK). In alternative embodiments, any other suitable format can be used.

When using the “atomic fetch-and-add with limit” command, it may be preferable to store CI in a memory of one of NICs 28. In such a configuration, the “atomic fetch-and-add with limit” command is issued in a peer-to-peer fashion between NICs, and processor 24 is not required to support it. Alternatively, CI may be stored in memory 44 of processor 44, or in any other suitable location. Further alternatively, CI may be stored in any suitable location when using a conventional atomic fetch-and-add command (without limit) as well.

In alternative embodiments, a NIC that caused CI overrun may correct the overrun by rolling back CI, i.e., decrementing CI back to its previous value.

In yet another embodiment, a NIC that caused CI overrun takes ownership of the erroneously-incremented CI (which currently points to a vacant location in the shared WQ) and waits for processor 24 to post a new WQE. The NIC then pulls the new WQE and executes the corresponding WR.

Further alternatively, NICs 28 may use any other suitable technique for preventing or correcting CI overrun scenarios.

### Joint Load Balancing and Quality-of-Service (QOS)

As noted above, in some embodiments system 20 comprises multiple shared WQs 48. For example, a given processor 24 may maintain multiple shared WQs 48. As another example, the system may comprise multiple processors 24, each processor maintaining one or more shared WQs 48. Thus, at a given time, a given NIC 28 may observe multiple shared WQs 48 having pending WQEs.

In various embodiments, NICs 28 serve the multiple shared WQs 48, and possibly one or more non-shared WQs, in accordance with a defined Quality-of-Service (QoS) criterion. Any suitable QoS criteria can be used. Example criteria include the following:
Ensure uniform fairness among the shared WQs.
Ensure a specified distribution (not necessarily even) of the traffic load among the shared WQs.
Ensure that a given shared WQ is allocated at least a specified percentage of the traffic bandwidth.
Maintain specified relative priorities among the shared WQs.

In various embodiments, NICs 28 may combine load balancing with QoS in different ways. In an example embodiment, QoS decisions are taken first, and load balancing decisions are taken second. In other words, a given NIC 28 first selects a WQ to serve, from among the multiple WQs (shared WQs, and non-shared WQs if such exist). Then, the NIC checks whether its estimated communication load is small enough to pull a new WQE. If so, the NIC pulls a WQE from the selected WQ.

FIG. 5 is a flow chart that schematically illustrates a method for joint load balancing and Quality-of-Service (QoS), in accordance with an embodiment that is described herein. The method is typically carried out by each of NICs 28, independently of other NICs. The description below refers to shared WQs only, for simplicity. Generally, the method can be applied jointly to a plurality of WQs, of which some are shared and others are non-shared.

The method begins at a pending work identification stage 114, in which the NIC identifies which of the multiple shared WQs currently have pending WQEs. At a QoS selection stage 118, the NIC selects a shared WQ from among the shared WQs having pending WQEs. The selection may be performed in accordance with any suitable QoS criterion, e.g., the criteria listed above.

In some embodiments, after selecting a shared WQ, the NIC checks the present congestion state of the selected WQ to see if it is permitted to transmit from this WQ. If not, the NIC repeats stage 118, i.e., uses the QoS criterion to select a different shared WQ to serve. In alternative embodiments, the NIC considers the congestion states of the various WQs as part of the QoS selection of stage 118 (i.e., applies the QoS criterion only to the WQs from which it is permitted to transmit in the first place).

At a load estimation stage 122, the NIC estimates its current or expected communication load. The load calculation may depend on the chosen WQ. At a load checking stage 126, the NIC checks whether the estimated load is sufficiently low to warrant obtaining additional work from shared WQs 48. If the estimated load is not sufficiently low, the NIC waits for the load to decrease, at a waiting stage 130, and loops back to stage 122. Stages 122-130 are parallel to stages 78-86 of FIG. 3 above.

If the estimated load is sufficiently low, the NIC pulls a WQE from the selected shared WQ 48 (the shared WQ selected at stage 118 above), at a pulling stage 134. The NIC executes the WR described by the new WQE, at an execution stage 138.

It will be appreciated that the embodiments described above are cited by way of example, and that the present invention is not limited to what has been particularly shown and described hereinabove. Rather, the scope of the present invention includes both combinations and sub-combinations of the various features described hereinabove, as well as variations and modifications thereof which would occur to persons skilled in the art upon reading the foregoing description and which are not disclosed in the prior art. Documents incorporated by reference in the present patent application are to be considered an integral part of the application except that to the extent any terms are defined in these incorporated documents in a manner that conflicts with the definitions made explicitly or implicitly in the present specification, only the definitions in the present specification should be considered.

1. A system, comprising (i) one or more processors, and (ii) multiple network devices to connect the one or more processors to a network, wherein:
the one or more processors are to issue work requests to the multiple network devices, by posting work descriptors on one or more shared queues that are each accessible to the multiple network devices; and
the network devices are to pull the work descriptors from the one or more shared queues, and to execute the work requests responsively to the work descriptors.

2. The system according to claim 1, wherein, in posting a work descriptor on the shared queue, a processor is to make the work descriptor available to any of the multiple network devices.

3. The system according to claim 1, wherein, upon issuing a work descriptor on a shared queue, a processor is to issue a doorbell to the multiple network devices, notifying the multiple network devices that the work descriptor has been posted.

4. The system according to claim 1, wherein a network device is to pull a work descriptor from the shared queue, not in response to an assignment of the work descriptor to the network device by the one or more processors.

5. The system according to claim 1, wherein a network device is to estimate a communication load experienced by the network device, and to pull a work descriptor in response to finding that the estimated communication load is sufficiently low, in accordance with a defined criterion.

6. The system according to claim 1, wherein:
the one or more shared queue are multiple shared queues that are each accessible to the multiple network devices;
the one or more processors are to issue the work requests to the multiple network devices by posting the work descriptors on the multiple shared queues; and
a network device is to choose a queue from among at least the multiple shared queues in accordance with a Quality-of-Service (QoS) criterion, and to pull a work descriptor from the chosen queue.

7. The system according to claim 1, wherein a shared queue is associated with a shared read pointer that is indicative of a head of the shared queue, and wherein, upon attempting to pull a work descriptor from the shared queue, a network device is to increment the read pointer using an atomic fetch-and-add command.

8. The system according to claim 7, wherein the atomic fetch-and-add command specifies a limit that prevents the incremented read pointer from overrunning a write pointer of the shared queue.

9. The system according to claim 8, wherein:
the one or more processors and the multiple network devices communicate over one or more peripheral buses using a bus communication protocol; and
the atomic fetch-and-add command is implemented as an extension of the bus communication protocol.

10. The system according to claim 7, wherein the read pointer is stored in a memory of one of the network devices, and wherein the network device is to perform the atomic fetch-and-add command in the memory of the one of the network devices.

11. The system according to claim 10, wherein the network device is to perform the atomic fetch-and-add command over a dedicated peer-to-peer connection between the network devices.

12. The system according to claim 7, wherein the read pointer is stored in a memory of one of the processors, and wherein the network device is to perform the atomic fetch-and-add command in the memory of the one of the processors.

13. The system according to claim 7, wherein the network device is to roll-back the incremented read pointer in response to finding that, following the atomic fetch-and-add command, the read pointer overruns a write pointer of the shared queue.

14. The system according to claim 7, wherein, in response to finding that the read pointer overruns a write pointer of the shared queue following the atomic fetch-and-add command, the network device is to wait for a processor to post a new work descriptor, and then pull the new work descriptor.

15. A method, comprising:
issuing work requests from one or more processors to multiple network devices that connect the one or more processors to a network, by posting work descriptors on one or more shared queues that are each accessible to the multiple network devices; and
in the multiple network devices, pulling the work descriptors from the one or more shared queues and executing the work requests responsively to the work descriptors.

16. The method according to claim 15, wherein posting a work descriptor on the shared queue comprises making the work descriptor available to any of the multiple network devices.

17. The method according to claim 15, further comprising, upon issuing a work descriptor on a shared queue, issuing a doorbell to the multiple network devices, notifying the multiple network devices that the work descriptor has been posted.

18. The method according to claim 15, wherein pulling a work descriptor from the shared queue, by a network device, is performed not in response to an assignment of the work descriptor to the network device by the one or more processors.

19. The method according to claim 15, wherein:
the one or more shared queue are multiple shared queues that are each accessible to the multiple network devices;
issuing the work requests to the multiple network devices comprises posting the work descriptors on the multiple shared queues; and
pulling the work descriptors comprises choosing a queue from among at least the multiple shared queues in accordance with a Quality-of-Service (QoS) criterion, and pulling a work descriptor from the chosen queue.

20. The method according to claim 15, wherein a shared queue is associated with a shared read pointer that is indicative of a head of the shared queue, and comprising, upon attempting to pull a work descriptor from the shared queue, incrementing the read pointer using an atomic fetch-and-add command.
